(19) United States
(12) Patent Application Publication
(10) Pub. No.: US 2016/0150189 A1
(43) Pub. Date: May 26, 2016

(54) IMAGE PROCESSING SYSTEM AND METHOD

(71) Applicant: CATERPILLAR INC., Peoria, IL (US)

(72) Inventors: Bradley Scott KRIEL, Pittsburgh, PA (US); Paul Edmund RYBSKI, Pittsburgh, PA (US)

(73) Assignee: CATERPILLAR INC., Peoria, IL (US)

(21) Appl. No.: 14/549,003

(22) Filed: Nov. 20, 2014

(51) Int. Cl. H04N 7/18; H04N 5/232; H04N 5/262; B60R 1/00

(52) U.S. Cl. CPC H04N 7/181; B60R 1/002; H04N 5/23238; H04N 5/2628; B60R 2300/105; B60R 2300/802; B60R 2300/303

(57) ABSTRACT

An image processing system is disclosed for an articulated machine. The system includes a plurality of cameras mounted on the machine for capturing images, and a machine state sensor for obtaining machine state data of machine. The system also includes a processor connected to the plurality of cameras and the machine state sensor, the processor being configured to establish camera extrinsic models for the plurality of cameras based on positions and orientations of the cameras, obtain the machine state data from the machine state sensor, establish a machine geometric model based on the machine state data, and establish image mapping rules for the plurality of cameras based on the machine geometric model and the camera extrinsic models. The processor is further configured to generate a unified image from the images captured by the plurality of cameras based on the image mapping rules, and render the unified image on a display.

### TECHNICAL FIELD

This disclosure relates generally to an image processing system and method and, more particularly, to an image processing system and method for generating unified images.

### BACKGROUND

Various machines, such as those that are used to dig, loosen, carry, compact, etc., different materials, may be equipped with image processing systems including cameras. The cameras capture images of the environment around the machine, and the image processing systems may use one or more static look-up tables to stitch the camera images to generate unified images and render the unified images on a display within the machine. Such image processing systems may assist the operators of the machines by increasing visibility and may be beneficial in applications where the operators' field of view is obstructed by portions of the machine or other obstacles.

Articulated machines, such as, wheel loaders, haul trucks, motor graders, and other types of heavy equipment, include a front section, a rear section, and an articulation joint connecting the front and rear frame members. As the machine articulates, an angle between two adjacent cameras mounted on the machine may be variable. The static look-up tables used for stitching images captured by the two adjacent cameras may be useless, because the variable angle between the two adjacent cameras may yield various camera extrinsics, on which the look-up tables are based.

An image processing system that may be used to process camera images for articulated machines is disclosed in U.S. Patent Publication No. 2014/0088824 (the '824 publication) to Ishimoto. The system of the '824 publication includes a camera position identifying unit for determining the positions of respective cameras based on an angle of articulation between a vehicle front section and a vehicle rear section about a pivot pin, an image transformation means for converting camera images captured by the cameras to bird's eye view images, respectively, and an image composing means for converting from the individually acquired bird's eye view images of the respective cameras to a composite bird's eye view image for displaying on a monitor. While the system of the '824 publication may be used to process camera images for articulated machines, it requires a converting process for each camera for converting the camera images to the bird's eye view images, and a separate composing process for converting the bird's eye view images to a composite bird's eye view image. In view of the amount of pixels needed to be processed in each image, the converting process and the composing process employed by the system of the '824 publication may be very computationally expensive.

The disclosed methods and systems are directed to solve one or more of the problems set forth above and/or other problems of the prior art.

### SUMMARY

In one aspect, this disclosure is directed to an image processing system for an articulated machine which includes a front section and a rear section connected to each other by an articulation joint. The system includes a plurality of cameras mounted on the machine for capturing images of an environment of the machine, and a machine state sensor for obtaining machine state data of machine. The system also includes a processor connected to the plurality of cameras and the machine state sensor, and configured to establish camera extrinsic models for the plurality of cameras based on positions and orientations of the cameras. Each camera extrinsic model corresponds to one of the plurality of cameras. The processor is also configured to obtain the machine state data from the machine state sensor, establish a machine geometric model based on the machine state data, and establish image mapping rules for the plurality of cameras based on the machine geometric model and the camera extrinsic models. Each image mapping rule corresponds to one of the plurality of cameras. The processor is further configured to generate a unified image from the images captured by the plurality of cameras based on the image mapping rules, and render the unified image on a display.

In another aspect, this disclosure is directed to a method for image processing. The method includes establishing camera extrinsic models for a plurality of cameras mounted on an articulated machine including a front section and a rear section connected to each other by an articulation joint. The camera extrinsic models are established based on positions and orientations of the cameras. Each camera extrinsic model corresponds to one of the plurality of cameras. The method also includes obtaining machine state data of the machine from the machine state sensor, establishing a machine geometric model based on the machine state data, and establishing image mapping rules for the plurality of cameras based on the machine geometric model and the camera extrinsic models. Each image mapping rule corresponds to one of the plurality of cameras. The method further includes generating a unified image from images captured by the plurality of cameras based on the image mapping rules, and rendering the unified image on a display.

In yet another aspect, this disclosure is directed to a machine. The machine includes a front section, a rear section, an articulation joint for connecting the rear section to the front section, a plurality of cameras mounted on the machine for capturing images of an environment of the machine, the plurality of cameras including at least a camera mounted on the front section and at least a camera mounted on the rear section, a machine state sensor for obtaining machine state data of machine, a processor connected to the plurality of cameras and the machine state sensor. The processor is configured to establish camera extrinsic models for the plurality of cameras based on positions and orientations of the cameras. Each camera extrinsic model corresponds to one of the plurality of cameras. The processor is also configured to obtain the machine state data from the machine state sensor, establish a machine geometric model based on the machine state data, and establish image mapping rules for the plurality of cameras based on the machine geometric model and the camera extrinsic models. Each image mapping rule corresponds to one of the plurality of cameras. The processor is further configured to generate a unified image from the images captured by the plurality of cameras based on the image mapping rules, and render the unified image on a display.

### BRIEF DESCRIPTION OF THE DRAWINGS

FIG. 1 schematically illustrates an exemplary articulated machine consistent with a disclosed embodiment.

FIG. 2 schematically illustrates an exemplary unified image consistent with a disclosed embodiment.

FIG. 3 schematically illustrates an exemplary image processing system consistent with a disclosed embodiment.

FIG. 4 illustrates a flowchart of a process of image processing consistent with a disclosed embodiment.

FIG. 5 schematically illustrates exemplary coordinate systems for a machine consistent with a disclosed embodiment.

FIG. 6 schematically illustrates an exemplary unified image consistent with a disclosed embodiment.

### DETAILED DESCRIPTION

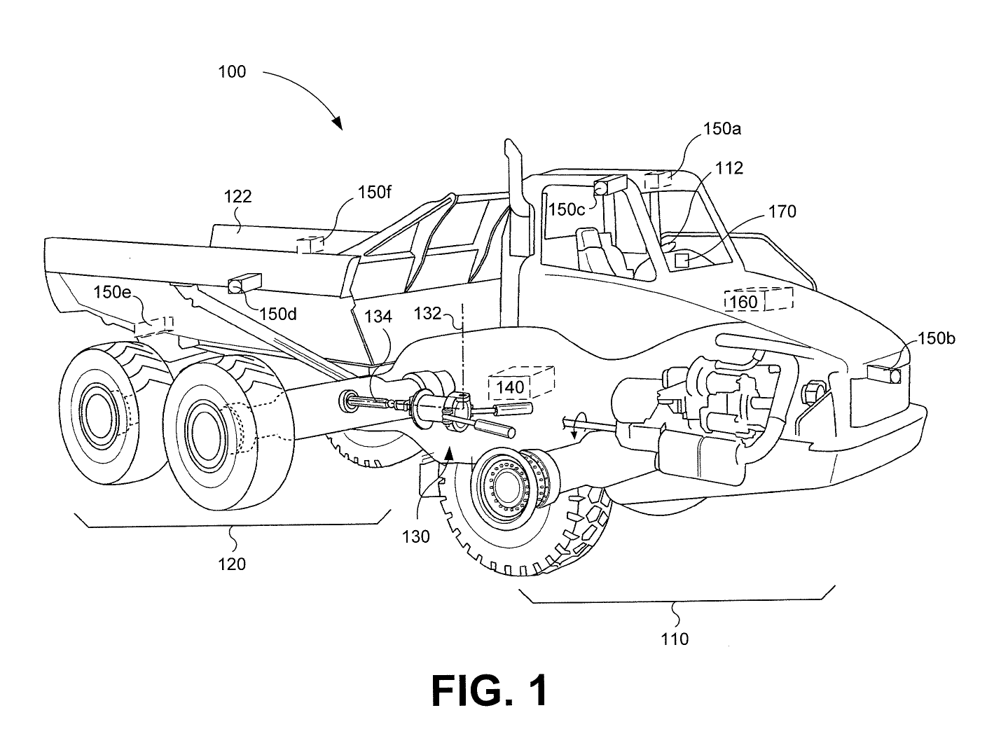

FIG. 1 schematically illustrates an exemplary articulated machine 100 (hereinafter referred to as “machine 100”) consistent with a disclosed embodiment. Machine 100, in the disclosed example, is an earth-moving machine. It is contemplated, however, that machine 100 may embody another type of mobile machine, if desired, such as a scraper, a wheel loader, a motor grader, or another machine known in the art.

Machine 100 may include a front section 110, a rear section 120, an articulation joint 130, a machine state sensor 140, a plurality of cameras 150a-150f, an image processing unit 160, and a display 170. Front section 110 may be a front tractor that includes multiple components that interact to provide power and control operations of machine 100. Front section 110 may include a steering wheel 112 as a control means of machine 100. Rear section 120 may be a rear trailer that includes a work tool 122 at the back end of machine 100. It should be noted, however, that other types of machines may alternatively include a front section that includes a work tool and a rear section that provides power and controls operation of the machines.

Front section 110 may be operatively connected to rear section 120 by articulation joint 130. Articulation joint 130 may include an assembly of components that cooperate to connect rear section 120 to front section 110, while still allowing some relative movements, i.e., e.g., articulation, between front section 110 and rear section 120. When an operator operates machine 100 by, e.g., operating steering wheel 112, front section 110 and rear section 120 may pivot about a vertical axis 132 and a horizontal axis 134 located at articulation joint 130.

While articulation joint 130 shown in FIG. 1 allows front section 110 and rear section 120 of machine 100 to pivot about vertical axis 132 and horizontal axis 134, those skilled in the art may appreciate that the relative movement between front section 110 and rear section 120 may exist in any manner. For example, articulation joint 130 may extend or retract along horizontal axis 134 such that the horizontal distance between front section 110 and rear section 120 may change. As another example, front section 110 and rear section 120 may pivot around an axis that is perpendicular to the plane formed by vertical axis 132 and horizontal axis 134.

Machine state sensor 140 may include one or more components that obtain machine state data of machine 100. The machine state data may include information related to current operation state of machine 100. For example, the machine state data may include the current articulation angle state of machine 100. The articulation angle state may include an articulation angle around vertical axis 132, and an articulation angle around horizontal axis 134. The machine state data may also include a distance between front section 110 and rear section 120, a current inclination angle of front section 110, a current inclination angle of rear section 120, and a current direction of machine 100.

Machine state sensor 140 may obtain the machine state data by direct measurement, or by calculation based on other measured data. For example, machine state sensor 140 may include an articulation sensor that is a rotational sensor mounted in or near articulation joint 130 for measuring the articulation angle state of machine 100, e.g. articulation angles of machine 100 around vertical axis 132 and horizontal axis 134. As another example, machine state sensor 140 may include an articulation sensor that is a hydraulic cylinder extension sensor for measuring the articulation angle state of machine 100. Alternatively, machine state sensor 140 may determine the articulation angles based on a steering angle of steering wheel 112. Machine state sensor 140 may transfer the machine state data to image processing unit 160.

The plurality of cameras 150a-150f may be mounted on machine 100 to capture images of an environment of machine 100. For example, cameras 150a-150f may be attached to the top of the frame of machine 100, or the roof of machine 100. Cameras 150a-150f may respectively capture images of the surroundings of machine 100, and transfer the captured images to image processing unit 160. In the example illustrated in FIG. 1, cameras 150a, 150b, and 150c are respectively mounted on the left side, front side, and right side of front section 110 of machine 100, and cameras 150d, 150e, and 150f are respectively mounted on the right side, rear side, and left side of rear section 120 of machine 100. While machine 100 in FIG. 1 is illustrated having six cameras 150a-150f, those skilled in the art will appreciate that machine 100 may include any number of cameras arranged in any manner.

Image processing unit 160 may receive the machine state data from machine state sensor 140 and receive the images captured by cameras 150a-150f. Image processing unit 160 may combine the captured images to generate a unified image based on the machine state data, and render the unified image on display 170.

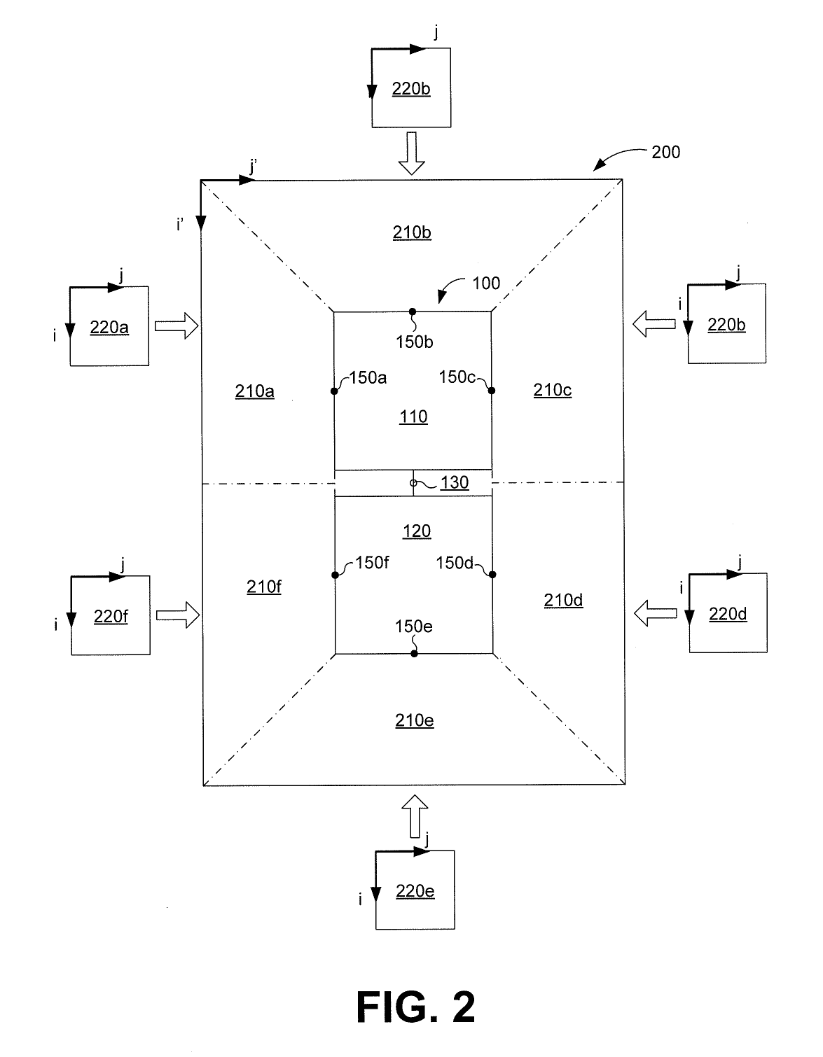

FIG. 2 schematically illustrates an exemplary unified image 200 consistent with a disclosed embodiment. Unified image 200 may include a top view of machine 100, and a bird's eye view image representing the environment of machine 100, as viewed from a virtual view point located above machine 100. Unified image 200 may include image sections 210a-210f, with each image section 210a-210f corresponding to one of images 220a-220f captured by cameras 150a-150f.

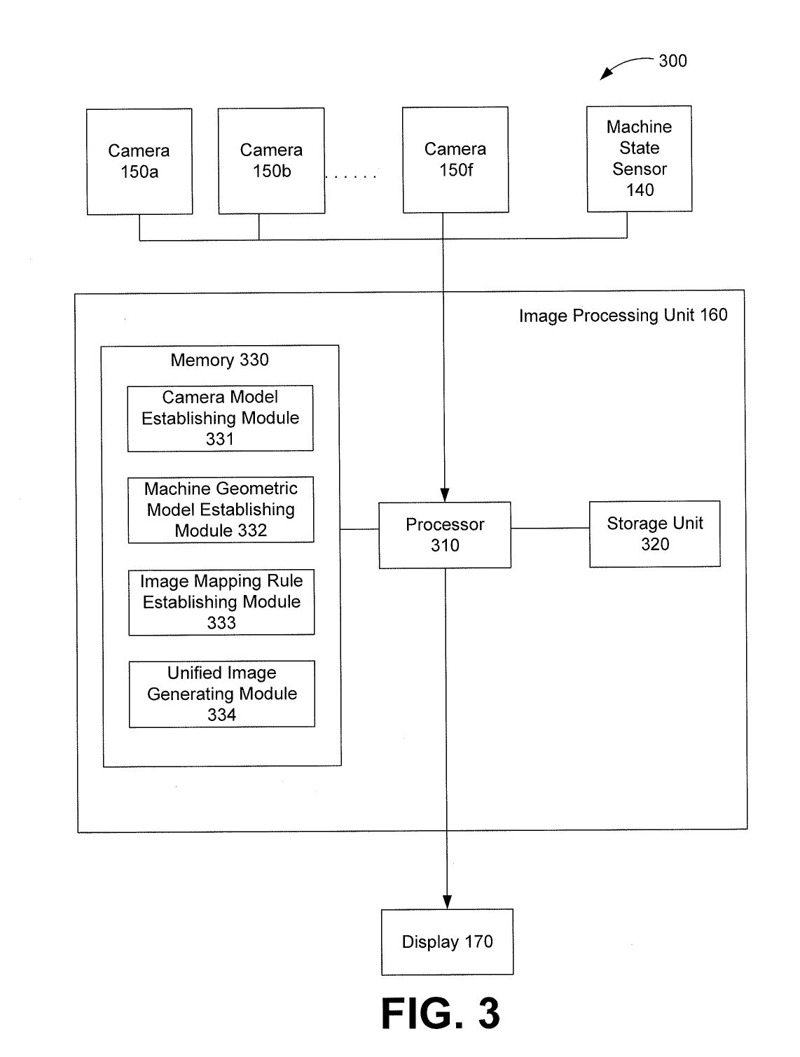

FIG. 3 schematically illustrates an exemplary image processing system 300 consistent with a disclosed embodiment. Image processing system 300 may include the plurality of cameras 150a-150f mounted on machine 100, machine state sensor 140, image processing unit 160, and display 170. Image processing unit 160 may include one or more of a processor 310, a storage unit 320, and a memory 330. Image processing unit 160 may be connected to the plurality of cameras 150a-150f, machine state sensor 140, and display 170 via a wired and/or wireless network. Although not illustrated in FIG. 3, image processing unit 160 may be connected via the wired and/or wireless network to one or more client terminals located remotely from machine 100. In addition, image processing unit 160 may be connected to input/output devices to communicate information associated with image processing unit 160. For example, image processing unit 160 may be connected to an integrated keyboard and mouse to allow a user to input parameters associated with image processing, e.g., positions and orientations of cameras 150a-150f. As another example, image processing unit 160 may be connected to printers to print out unified image 200. Image processing unit 160 may be implemented as a stand-alone component mounted on either one of front section 110 and rear section 120 of machine 100. Alternatively, image processing unit 160 may be included in an electronic control module (ECM) of machine 100.

Processor 310 may include one or more processing devices that are configured to perform various processes and methods consistent with certain disclosed embodiments. For example, processor 310 may be capable of processing captured images 220a-220f and generate unified image 200 in real time, e.g., at more than 30 frames per second. For example, in order to generate unified image 200 at 30 frames per second, processor 310 may be required to process seven (7) frames of images (6 captured images 220a-220f plus one unified image 200) for each frame of unified image 200, and thus process 210 (=7×30) frames per second. If each frame includes one million pixels (1 MP), processor 310 may be required to process 210 MP per second. In order to perform such a computationally expensive task, processor 310 may include one or more processing devices that are capable of performing multiple tasks in parallel, i.e., process multiple images in parallel, in order to rapidly process captured images 220a-220f and generate unified image 200. For example, processor 310 may be a graphics processing unit (GPU), a field-programmable gate array (FPGA), or an application-specific integrated circuit (ASIC).

As illustrated in FIG. 3, processor 310 may be communicatively coupled to storage unit 320 and memory 330. In one exemplary embodiment, computer program instructions may be stored in storage unit 320, and may be loaded into memory 330 for execution by processor 310.

Storage unit 320 may include a non-volatile, magnetic, semiconductor, tape, optical, removable, nonremovable, or other type of storage device or computer-readable medium. Storage unit 320 may store programs and/or other information that may be used by processor 310. In one embodiment, storage unit 320 may store geometric information of machine 100, and location and orientation information of each of cameras 150a-150f.

Memory 330 may include a volatile memory device configured to temporarily store information used by processor 310 to perform certain functions related to the disclosed embodiments. In one embodiment, memory 330 may include one or more modules (e.g., collections of one or more programs or subprograms) loaded from storage unit 320 or elsewhere that perform (i.e., that when executed by processor 310, enable processor 310 to perform) various procedures, operations, or processes consistent with the disclosed embodiment.

For example, memory 330 may include a camera model establishing module 331, a machine geometric model establishing module 332, an image mapping rule establishing module 333, and a unified image generating module 334. Camera model establishing module 331 may enable processor 310 to establish a camera extrinsic model for each of cameras 150a-150f based on the locations and orientation of cameras 150a-150f. Machine geometric model establishing module 332 may enable processor 310 to dynamically establish a machine geometric model based on the machine state data of machine 100. The machine geometric model may represent the current geometric information of machine 100. “Dynamically”, as used herein, refers to a process that is performed instantaneously in real time during the operation of machine 100, i.e., as machine 100 moves. For example, in order to generate the unified image at 30 frames per second, processor 310 may dynamically generate the machine geometric model 30 times per second. Image mapping rule establishing module 333 may enable processor 310 to dynamically establish an image mapping rule for each of cameras 150a-150f based on the camera extrinsic models and the machine geometric model. The image mapping rules may be used to map pixels of captured images 220a-220f to unified image 200. Unified image generating module 334 may enable processor 310 to generate unified image 200 by combining captured images 220a-220f based on the image mapping rules.

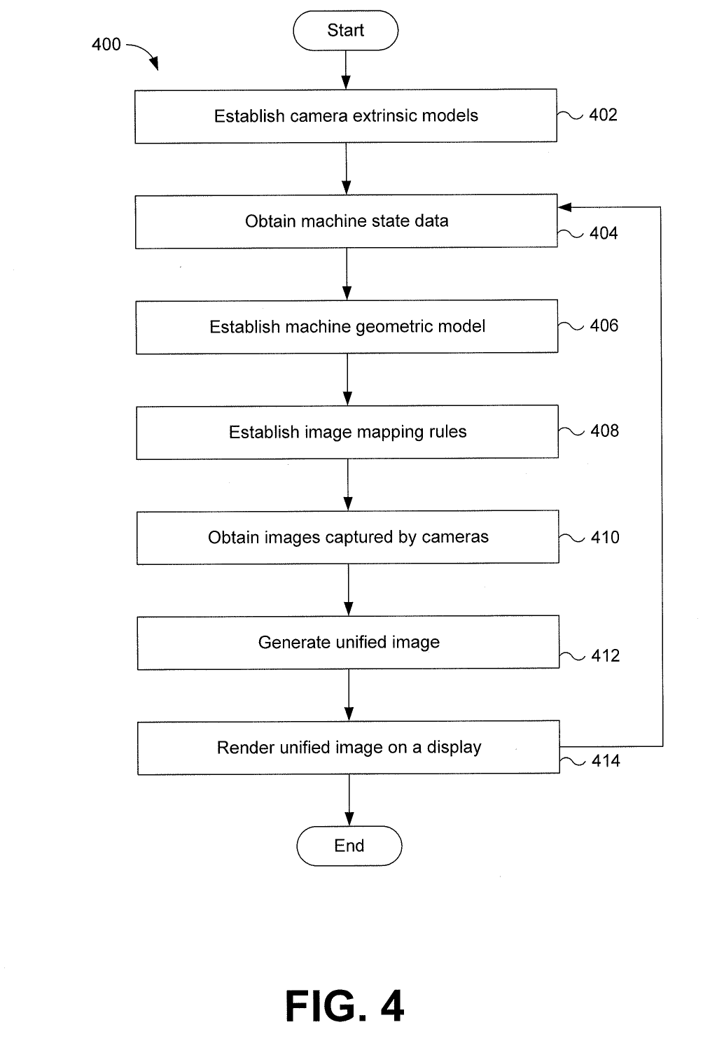

The operation of processor 310 in image processing unit 160 will now be described in connection with FIG. 4, which illustrates a flowchart of a process 400 of image processing performed by processor 310, consistent with a disclosed embodiment.

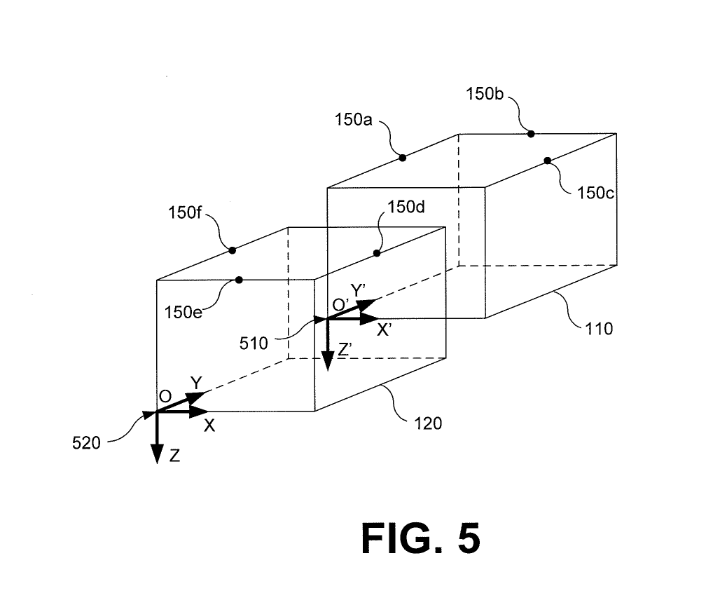

Processor 310 may first establish camera extrinsic models for cameras 150a-150f (step 402). Each camera extrinsic model may correspond to one of cameras 150a-150f, and may represent the location and orientation of the corresponding camera with respect to a coordinate system for one of front section 110 and rear section 120 on which the corresponding camera is mounted. The coordinate system and the camera extrinsic models will be explained in more detail in connection with FIG. 5. Processor 310 may establish the camera extrinsic models based on location and orientation data of cameras 150a-150f. The location and orientation data may be input by a user when cameras 150a-150f were installed, and may be stored in storage unit 320. Once the camera extrinsic models are established, processor 310 may store the established camera extrinsic models in storage unit 320.

FIG. 5 schematically illustrates exemplary coordinate systems for machine 100 consistent with a disclosed embodiment. As illustrated in FIG. 5, machine 100 may include a front coordinate system 510 for front section 110, and a rear coordinate system 520 for rear section 120. Front coordinate system 510 may be a Cartesian coordinate system with an origin point O′ and three axes X′, Y′, and Z′. Rear coordinate system 520 may be a Cartesian coordinate system with an origin point) and three axes X, Y, and Z. Although in the embodiment illustrated in FIG. 5, both front coordinate system 510 and rear coordinate system 520 are Cartesian coordinate system, it is contemplated that front coordinate system 510 and/or rear coordinate system 520 may be other coordinate systems such as polar coordinate systems, cylindrical coordinate systems, and spherical coordinate systems. In addition, the origin points of front coordinate system 510 and rear coordinate system 520 may be positioned at locations different than the ones illustrated in FIG. 5. Similarly, the orientation of the axes in front coordinate system 510 and rear coordinate system 520 may be different than the ones illustrated in FIG. 5.

The camera extrinsic models may represent the locations and orientations of cameras 150a-150f with respect to their respectively corresponding coordinate systems. That is, the camera extrinsic models of cameras 150a-150c may respectively represent the locations and orientations of cameras 150a-150c with respect to front coordinate system 510 for front section 110 of machine 100 on which cameras 150a-150c are mounted. Similarly, the camera extrinsic models of cameras 150d-150f may respectively represent the locations and orientations of cameras 150d-150f with respect to rear coordinate system 520 for rear section 120 of machine 100 on which cameras 150d-150f are mounted. Each camera extrinsic model may include six parameters, three parameters x, y, and z representing the location of a camera with respect to the corresponding coordinate system, and three parameters yaw, pitch, and roll representing the orientation of the camera with respect to the corresponding coordinate system. For example, the camera extrinsic model of camera 150c may include x, y, z, yaw, pitch, and roll, representing the location and orientation of camera 150c with respect to front coordinate system 510.

Because the camera extrinsic models represent the locations and orientations of cameras 150a-150f with respect to their respectively corresponding coordinate systems, and because cameras 150a-150f do not move with respect to their respectively corresponding coordinate systems as machine 100 articulates, the camera extrinsic models are static and do not change as machine 100 articulates. According to the disclosed embodiment, processor 310 may advantageously limit the amount of data being processed by pre-establishing the camera extrinsic models before the operation of machine 100, and storing the pre-established camera extrinsic models in storage unit 320. During the operation of machine 100, processor 310 may load the pre-established camera extrinsic models from storage unit 320, and process images based on the pre-established camera extrinsic models. Pre-establishing and storing of the camera extrinsic models may greatly reduce the image processing time for processor 310.

Although not illustrated in FIG. 4, processor 310 may also establish camera intrinsic models for cameras 150a-150f, with each camera intrinsic model corresponding to one of cameras 150a-150f. The camera intrinsic models may respectively represent distortion of images 220a-220f captured by cameras 150a-150f.

Referring back to FIG. 4, once the camera extrinsic models are established in step 402, processor 310 may obtain machine state data from machine state sensor 140 (step 404). As explained previously, the machine state data may include information regarding current operation state of machine 100. For example, the machine state data may include an articulation angle state including an articulation angle around vertical axis 132, and an articulation angle around horizontal axis 134. The machine state data may additionally include a distance between front section 110 and rear section 120, a current inclination angle of front section 110, a current inclination angle of rear section 120, and a current direction of machine 100. Processor 310 may store the obtained machine state data in storage unit 320 or memory 330.

Processor 310 may establish a machine geometric model based on the machine state data of machine 100 (step 406). The machine geometric model may represent the current geometric information of machine 100 as machine 100 moves, e.g., articulates. For example, the machine geometric model may represent the relative position and orientation between front section 110 and rear section 120. Referring to FIG. 5, the machine geometric model may represent the position and orientation of front coordinate system 510 with respect to rear coordinate system 520. Similar to the camera extrinsic models, the machine geometric model may include six parameters, three parameters x, y, and z representing the location of the origin point O′ of front coordinate system 510 with respect to rear coordinate system 520, and three parameters yaw, pitch, and roll representing the orientation of front coordinate system 510 with respect to rear coordinate system 520. Alternatively, the machine geometric model may represent the position and orientation of rear coordinate system 520 with respect to front coordinate system 510.

Once the machine geometric model is established in step 406, processor 310 may establish image mapping rules for cameras 150a-150f (step 408). Processor 310 may establish the image mapping rules based on the camera extrinsic models established in step 402 and the machine geometric model established in step 406. Each image mapping rule may correspond to one of cameras 150a-150f. For example, as illustrated in FIG. 2, image 220a captured by camera 150a may be mapped to image section 210a based on an image mapping rule for camera 150a, image 220b captured by camera 150b may be mapped to image section 210b based on an image mapping rule for camera 150b, etc.

Each image mapping rule may define a position in unified image 200 for each pixel in image 220a-220f captured by the corresponding camera 150a-150f. In other words, each image mapping rule may correlate a pixel in the image 220a-220f captured by the corresponding camera 150a-150f to one or more pixels in unified image 200. Generally, image pixels may be arranged in a regular two-dimensional grid, and each pixel may be indexed by (i, j), in which the i-value indicates the i-th row of the two-dimensional grid and the j-value indicates the j-th column of the two-dimensional grid. An image mapping rule for a camera may map the i and j values of the pixels in the image captured by the camera to i′ and j′ values in unified image 200. For example, a pixel located at (1,1) in image 220a captured by camera 150a may be mapped to location (300, 200) of unified image 200.

The image mapping rule may be implemented by a look-up table that maps the i and j values of pixels in a captured image to i′ and j′ values in unified image 200. Alternatively, the image mapping rule may be implemented as one or more mathematical equations that are used to calculate the i′ and j′ values of pixels in the unified image from the i and j values of pixels in a captured image. Processor 310 may establish the image mapping rules in parallel. That is, the image mapping rules for cameras 150a-150f may be simultaneously established by processor 310.

Processor 310 may establish the image mapping rules based on the positions and orientations of cameras 150a-150f with respect to a global coordinate system for unified image 200. The global coordinate system may be selected from front coordinate system 510 and rear coordinate system 520, based on which one of front section 110 and rear section 120 is relatively stationary when machine 100 articulates.

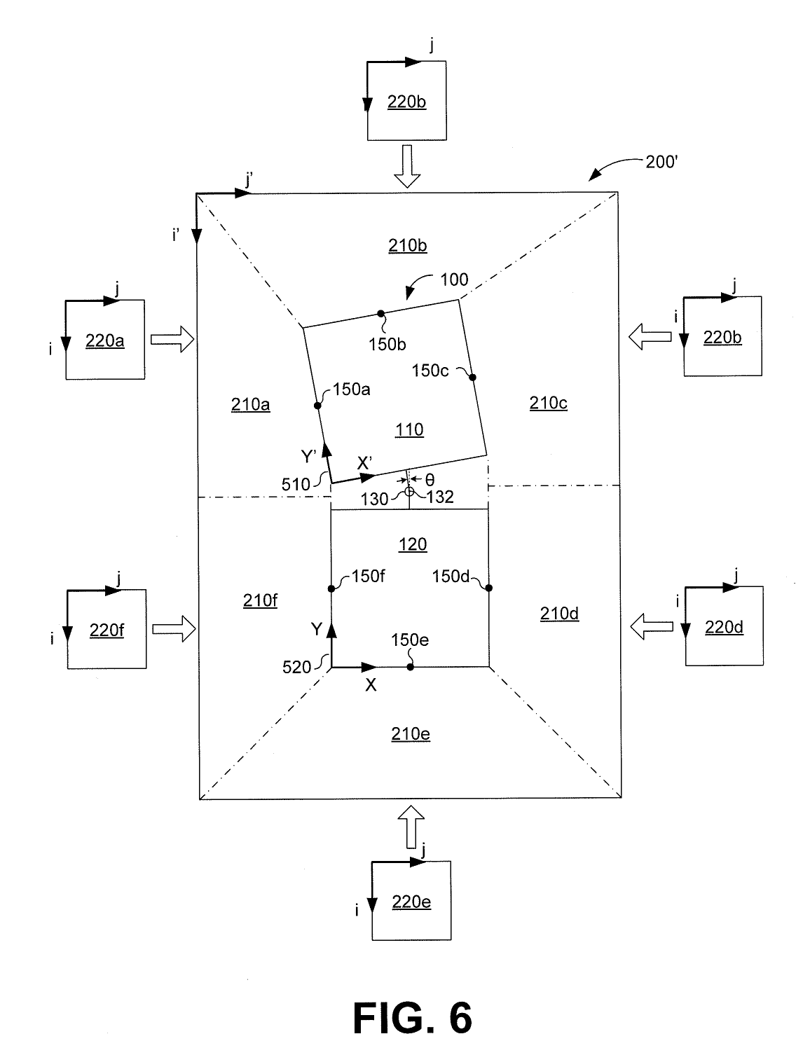

FIG. 6 schematically illustrates an exemplary unified image 200′ generated when machine 100 articulates, consistent with a disclosed embodiment. Front section 110 and rear section 120 may pivot about vertical axis 132 located at articulation joint 130, to form an articulation angle θ. In the example illustrated in FIG. 6, rear section 120 is relatively stationary when machine 100 articulates, while front section 110 is relatively moving. Therefore, rear coordinate system 520 may be selected as the global coordinate system for unified image 200′. Processor 310 may generate the image mapping rules based on the positions and orientations of cameras 150a-150f with respect to rear coordinate system 520. The positions and the orientations of cameras 150d-150f mounted on rear section 120 may be fixed in coordinate system 520 regardless of whether machine 100 articulates or not. Therefore, processor 310 may obtain the positions and orientations of cameras 150d-150f based on the camera extrinsic models established in step 402. On the other hand, the positions and the orientations of cameras 150a-150c mounted on front section 110 may change in coordinate system 520 as machine 100 articulates. In order to dynamically establish the image mapping rules for cameras 150a-150c, the positions and orientations of cameras 150a-150c with respect to coordinate system 520 may need to be constantly updated. However, instead of constantly inquiring the positions and orientations of individual cameras 150a-150c with respect to coordinate system 520, processor 310 of the disclosed embodiment may establish the camera extrinsic models for cameras 150a-150f with respect to front coordinate system 510 in step 402, establish the machine geometric model representing the relative position of front coordinate system 510 with respect to rear coordinate system 520 in step 406, and obtain the positions and orientations of cameras 150a-150c with respect to coordinate system 520 based on a hierarchical model that is a combination of the machine geometric model and the camera extrinsic models of cameras 150a-150c. For example, processor 310 may obtain the position and orientation of camera 150a with respect to coordinate system 520 based on a hierarchical model that is a combination of the machine geometric model representing the relative position of front coordinate system 510 with respect to rear coordinate system 520, and the camera extrinsic model representing the relation position and orientation of camera 150a with respect to front coordinate system 510. Such a process may greatly reduce the processing time of processor 310.

Each image mapping rule may also define a subset or all of the pixels in the image 220a-220f captured by the corresponding camera 150a-150f to be included in unified image 200. When fields of view of at least two of images 220a-220f overlap, a conflict arises as to which pixel of images 220a-220f may be included in unified image 200. Processor 310 may resolve the conflict based on parameters associated with cameras 150a-150f and positions and orientation of cameras 150a-150f. For example, processor 310 may determine whether an overlap portion exists between images 220a-220f based on the positions and orientation of cameras 150a-150f. When processor 310 determines that an overlap portion exists between image 220a captured by camera 150a and image 220b captured by camera 150b, processor 310 may define a boundary within the overlapping portion. Processor 310 may then establish image mapping rules to map image 220a to one side of the boundary, and image 220b to the other side of the boundary. Alternatively, when processor 310 determines that an overlap portion exists between image 220a and image 220b, processor 310 may determine which one of camera 150a and 150b has a higher priority based on the parameters associated with cameras 150a and 150b. If camera 150a has the higher priority, processor 310 may establish image mapping rules to map image 220a to the overlapping portion. Otherwise, if camera 150b has the higher priority, processor 310 may establish image mapping rules to map image 220b to the overlapping portion. Still alternatively, processor 310 may define a transparency value, and then establish image mapping rules to blend a portion of image 220a and a portion of image 220b within the overlapping portion.

Referring back to FIG. 4, processor 310 may obtain images 220a-220f captured by cameras 150a-150f (step 410). Processor 310 may obtain analog signal data from cameras 150a-150f, and may convert the signals to images 220a-220f based on the camera intrinsic models of cameras 150a-150f. Alternatively, the image mapping rules may be used to map the analog signal data to pixels in unified image 200. In such case, the image mapping rules may be established based on the camera intrinsic models of cameras 150a-150f, the camera extrinsic models of cameras 150a-150f, and the machine geometric model.

Processor 310 may then generate unified image 200 (step 412). Processor 310 may generate unified image 200 from captured images 220a-220f based on the image mapping rules established in step 408. For example, processor 310 may map pixels of captured images 220a-220f into image sections 210a-210f of unified image 200 based on the respective image mapping rules. Processor 310 may perform the mapping in parallel. That is, processor 310 may simultaneously map pixels of captured images 220a-220f into image sections 210a-210f.

Once the unified image 200 is generated, processor 310 may also render unified image 200 on display 170 (step 414). Afterwards, processor 310 may repeat steps 404-414, until receiving an instruction to stop.

Although machine 100 illustrated in FIG. 1 includes two sections, i.e., front section 110 and rear section 120, those skilled in the art may appreciate that the disclosed image processing system 300 may be applicable for an articulated machine including more than two sections. For example, if a machine includes three sections, i.e., a first section, a second section, and a third section, image processing system 300 may obtain the articulation angle state between the first section and the second section, and the articulation angle state between the second state and the third state. Image processing system 300 may establish a machine geometric model representing the relative positions and orientations between the first through third sections. Image processing system 300 may then establish the image mapping rules for a plurality of cameras mounted on the first through third sections based on the machine geometric model.

### INDUSTRIAL APPLICABILITY

The disclosed image processing system 300 may be applicable to any machine that includes one or more articulation joints connecting different sections together. The disclosed image processing system 300 may enhance operator awareness by rendering a unified imaged on a display based on the current articulation angle state of the machine.

The disclosed image processing system 300 may pre-establish the camera extrinsic models that represent the locations and orientations of cameras 150a-150f in their corresponding coordinate systems before the operation of machine 100, and store the pre-established camera extrinsic models in storage unit 320. During the operation of machine 100, it is not necessary for image processing system 300 to inquire about the locations and orientations of cameras 150a-150f. Instead, image processing system 300 may only inquire about an articulation angle state of machine 100, establish a machine geometric model based on the articulation angle state of machine 100, and may obtain the locations and orientations of cameras 150a-150f by combining the camera extrinsic models and the machine geometric model. Thus, the image processing time is greatly reduced.

The disclosed image processing system 300 may establish image mapping rules for cameras 150a-150f, and may generate unified image 200 from the images captured by cameras 150a-150f based on the image mapping rules. Thus, it is not necessary for image processing system 300 to transform the images captured by cameras 150a-150f to individual bird's eye view images, and then stitch the individual bird's eye view images together. Thus, the amount of data being processed by image processing system 300 is greatly reduced.

It will be apparent to those skilled in the art that various modifications and variations can be made to the disclosed image processing system 300. Other embodiments will be apparent to those skilled in the art from consideration of the specification and practice of the disclosed parts forecasting system. It is intended that the specification and examples be considered as exemplary only, with a true scope being indicated by the following claims and their equivalents.

What is claimed is:

1. An image processing system for an articulated machine including a front section and a rear section connected to each other by an articulation joint, comprising:
a plurality of cameras mounted on the machine for capturing images of an environment of the machine;
a machine state sensor for obtaining machine state data of machine;
a processor connected to the plurality of cameras and the machine state sensor, the processor being configured to:
establish camera extrinsic models for the plurality of cameras based on positions and orientations of the cameras, with each camera extrinsic model corresponding to one of the plurality of cameras;
obtain the machine state data from the machine state sensor;
establish a machine geometric model based on the machine state data;
establish image mapping rules for the plurality of cameras based on the machine geometric model and the camera extrinsic models, with each image mapping rule corresponding to one of the plurality of cameras;
generate a unified image from the images captured by the plurality of cameras based on the image mapping rules; and
render the unified image on a display.

2. The image processing system of claim 1, wherein
the plurality of cameras include at least one camera mounted on the front section and at least one camera mounted on the rear section, and
each camera extrinsic model represents the location and orientation of a corresponding camera with respect to one of the front section and the rear section on which the corresponding camera is mounted.

3. The image processing system of claim 1, wherein the processor is configured to:
establish the camera extrinsic models and store the established camera extrinsic models in a storage unit before the machine operates; and
load the camera extrinsic models from the storage unit during the operation of the machine.

4. The image processing system of claim 1, wherein the processor is configured to establish camera intrinsic models for the plurality of cameras.

5. The image processing system of claim 1, wherein the machine state data may include an articulation angle state of the machine.

6. The image processing system of claim 1, wherein the machine geometric model represents the relative position and orientation between the front section and the rear section.

7. The image processing system of claim 1, wherein each image mapping rule defines a position in the unified image for each pixel in the image captured by the corresponding camera.

8. The image processing system of claim 1, wherein the processor is configured to establish the image mapping rules in parallel.

9. The image processing system of claim 1, wherein
the processor is configured to generate the unified image by mapping pixels of the images captured by the plurality of cameras into corresponding sections in the unified image based on the respective image mapping rules.

10. The image processing system of claim 1, wherein the processor is configured to map the pixels in the captured images in parallel.

11. The image processing system of claim 1, wherein the processor is one of a graphics processing unit (GPU), a field-programmable gate array (FPGA), or an application-specific integrated circuit (ASIC).

12. A method for image processing, the method comprising the following operations performed by at least one processor:
establishing camera extrinsic models for a plurality of cameras mounted on an articulated machine including a front section and a rear section connected to each other by an articulation joint, with the camera extrinsic models being established based on positions and orientations of the cameras, and each camera extrinsic model corresponding to one of the plurality of cameras;
obtaining machine state data of the machine from a machine state sensor;
establishing a machine geometric model based on the machine state data;
establishing image mapping rules for the plurality of cameras based on the machine geometric model and the camera extrinsic models, with each image mapping rule corresponding to one of the plurality of cameras;
generating a unified image from images captured by the plurality of cameras based on the image mapping rules; and
rendering the unified image on a display.

13. The method of claim 12, wherein
the plurality of cameras include at least one camera mounted on the front section and at least one camera mounted on the rear section, and
each camera extrinsic model represents the location and orientation of a corresponding camera with respect to one of the front section and the rear section on which the corresponding camera is mounted.

14. The method of claim 12, further including:
establishing the camera extrinsic models and store the established camera extrinsic models in a storage unit before the machine operates; and
loading the camera extrinsic models from the storage unit during the operation of the machine.

15. The method of claim 12, wherein the machine state data may include an articulation angle state of the machine.

16. The method of claim 12, wherein the machine geometric model represents the relative position and orientation between the front section and the rear section.

17. The method of claim 12, wherein each image mapping rule defines a position in the unified image for each pixel in the image captured by the corresponding camera.

18. The method of claim 12, further including establishing the image mapping rules in parallel.

19. The method of claim 12, further including generating the unified image by mapping pixels of the images captured by the plurality of cameras into corresponding sections in the unified image based on the respective image mapping rules.

20. A machine, comprising:
a front section;
a rear section;
an articulation joint for connecting the rear section to the front section;
a plurality of cameras mounted on the machine for capturing images of an environment of the machine, the plurality of cameras including at least a camera mounted on the front section and at least a camera mounted on the rear section;
a machine state sensor for obtaining machine state data of machine; and
a processor connected to the plurality of cameras and the machine state sensor, the processor being configured to:
establish camera extrinsic models for the plurality of cameras based on positions and orientations of the cameras, with each camera extrinsic model corresponding to one of the plurality of cameras;
obtain the machine state data from the machine state sensor;
establish a machine geometric model based on the machine state data;
establish image mapping rules for the plurality of cameras based on the machine geometric model and the camera extrinsic models, with each image mapping rule corresponding to one of the plurality of cameras;
generate a unified image from the images captured by the plurality of cameras based on the image mapping rules; and
render the unified image on a display.
